(19) United States
(12) Patent Application Publication
(10) Pub. No.: US 2026/0160320 A1
(43) Pub. Date: Jun. 11, 2026

(54) GEAR, ASSEMBLY AND GEAR MECHANISM

(71) Applicant: IMS GEAR SE & CO. KGAA, Donaueschingen (DE)

(72) Inventor: Sebastian BREITHAUPT, Marbach (DE)

(21) Appl. No.: 19/405,167

(22) Filed: Dec. 1, 2025

(30) Foreign Application Priority Data
Dec. 10, 2024 (EP) 24218777.1

(51) Int. Cl. F16H 55/18; F16H 55/08

(52) U.S. Cl. CPC F16H 55/18; F16H 55/08

(57) ABSTRACT

Gear (16) for a gear mechanism, comprising
an axis of rotation (18) with an axial direction (20) and a circumferential direction (22), a plurality of gear parts (24, 26, 50) designed as separate components and arranged adjacent to each other in the axial direction (20),
wherein each of the gear parts (24, 26, 50) has a toothed ring (28) circumferentially arranged around the axis of rotation (18), wherein the gear parts (24, 26, 50) can each be brought into a coupled state by rotating them relative to one another in the circumferential direction (22), in which state the gear parts (24, 26, 50) are each firmly connected to one another in the axial direction (20),
and wherein the gear parts (24, 26, 50) are arranged, in the coupled state, without any biasing relative to each other in the circumferential direction (22),
and an assembly (10) with such a gear,
as well as a gear mechanism with such a gear.

The invention relates to a gear, an assembly with such a gear and a gear mechanism.

Gearings with plastic gears are used in many areas of technology, for example in actuators in motor vehicles, in the drive train of electrically powered bicycles or in industrial applications. In particular, the planet gears arranged in the planetary gearings used in these areas are designed as plastic gears.

Up to now, plastic gears have mostly been manufactured as injection-molded plastic parts. To attach the plastic gears to a central element, such as a shaft or a bearing, the central element is usually placed in the injection mold and then overmolded with the plastic of the gear to be manufactured. When the plastic cools, shrinkage stresses typically occur in the gear, which can already consume a large part of the available strength potential of the plastic. This can result in a short lifespan for such gears.

Furthermore, the described manufacturing process carries the risk that the central element inserted into the injection mold will be damaged during overmolding. During the overmolding of roller bearings, in particular at high tool temperatures, lubricant may escape from the roller bearings. The escaping lubricant may in turn contaminate the injection mold or the plastic.

In addition, multi-part gear assemblies with a main gear and a secondary gear are known from the prior art, which can be manufactured independently of a central element and subsequently mounted on a central element. When assembled, the main gear and the secondary gear are spring-loaded against each other in the circumferential direction around the axis of rotation. Such an arrangement serves to eliminate the play between meshing gears. The following documents are listed as representing the relevant prior art in printed form: DE 10 2011 122 138 A1, US 2013/0 213 168 A1, US 2018/0 017 151 A1, and US 2013/0 112 027 A1.

Such arrangements are mainly used for metallic gears, for example, those produced by powder metallurgy. Disadvantages of these arrangements include increased friction in the tooth engagement and thus increased wear, as well as increased manufacturing costs and, in particular, assembly costs. For example, attaching such a gear assembly to a central element requires additional manufacturing and/or assembly steps. In particular, a separate axial securing device is required in the known examples.

It is therefore the object of the invention to provide a gear assembly that has a long service life and is easy to manufacture.

The object is achieved according to the invention by a gear with the features of claim 1, an assembly with the features of claim 13 and a gear mechanism with the features of claim 14.

Advantageous embodiments and developments of the invention are specified in the dependent claims.

A gear according to the invention, in particular a spur gear, for a gear mechanism comprises an axis of rotation with an axial direction and a circumferential direction. The term axial direction is used here and in the following preferably to refer to both, opposite directions along the axis of rotation. Similarly, the term circumferential direction can be understood here and in the following as referring to both directions extending around the axis of rotation and opposite relative to each other. The axial direction is preferably arranged perpendicular to the circumferential direction. Unless otherwise stated, the terms “axial” and “radial” used here and below shall refer to the axis of rotation.

The gear according to the invention comprises a plurality of gear parts designed as separate components and arranged adjacent to each other in the axial direction, each of the gear parts having a toothed ring circumferentially arranged around the axis of rotation. Preferably, the toothed ring is circumferentially arranged around the axis of rotation. The gear parts are preferably arranged coaxially to the axis of rotation. The gear parts can each be brought into a coupled state by rotating them relative to each other in the circumferential direction, in which state the gear parts are firmly connected to each other in the axial direction. This means that each of the gear parts must preferably be rotated relative to the adjacent gear parts in order to be brought from a decoupled state to the coupled state. In the coupled state, the gear parts may be, in particular positively, connected to each other. Due to the arrangement being firmly connected in the axial direction, axial forces can preferably be transmitted between the gear parts that are in the coupled state.

According to the invention, the gear parts are arranged, in the coupled state, without any biasing relative to each other in the circumferential direction. In particular, the gear is free of a biasing element, such as a spring element, which would initiate a biasing force between the individual gear parts. This allows for the provision of a low-wear and easy-to-manufacture gear.

Preferably, the gear parts are arranged to be rotatable relative to each other in the circumferential direction when coupled. When engaging with a mating gear of the gear, the gear parts can align themselves with the mating gear, so that the gear can compensate for tolerances such as misalignments or deformations of axles.

The toothed ring of each of the gear parts may have a plurality of teeth with tooth end faces arranged perpendicular to the axis of rotation, wherein, in the coupled state, adjacent gear parts can each be arranged such that their tooth end faces are arranged opposite each other in the axial direction. Preferably, none of the tooth end faces are positioned opposite a tooth gap between the teeth. Such an arrangement preferably corresponds to the arrangement of the tooth end faces relative to each other when the gear is in engagement with the mating gear. This allows the gear parts to be firmly connected to each other in the axial direction when engaged with a mating gear. Preferably, the tooth end faces of adjacent gear parts abut each other and are particularly preferably arranged without offset relative to each other in the circumferential direction. In the axial direction, the gear preferably has a continuous tooth profile.

In a preferred embodiment of the invention, the gear parts are designed as injection-molded parts, preferably as plastic injection-molded parts. Preferably, each of the gear parts is designed as a plastic injection-molded part. This allows the gear to be manufactured in large quantities at low cost and with high accuracy. Because the gear is made up of the plurality of gear parts, it can easily be mounted on a central element, such as a bearing or a shaft.

The gear parts have the same and/or different helix angles. This makes it easy to implement different types of gearing. If all gear parts have the same helix angle, the gear can be designed with straight or helical teeth. A herringbone gear can be easily created using two gear parts whose helix angles are equal in magnitude but differ in sign.

Preferably, at least one gear part of the gear parts has at least one first coupling element. Particularly preferably, each of the gear parts has at least one first coupling element. The at least one first coupling element may be arranged on a first end face of the at least one gear part, which first end face is preferably arranged perpendicular to the axis of rotation. Preferably, the at least one first coupling element is designed to project beyond the first end face in the axial direction. The at least one gear part may comprise a plurality of, preferably three, first coupling elements of the at least one first coupling element, which may be arranged evenly distributed in the circumferential direction.

Particularly preferably, at least one gear part of the gear parts has at least one second coupling element that can be coupled to the at least one first coupling element. By the interaction of the at least one first coupling element with the at least one second coupling element, the coupled state can preferably be established. Preferably, each of the gear parts has at least one second coupling element that can be coupled to the at least one first coupling element. The at least one second coupling element may be arranged on the first end face of the at least one gear part. Preferably, the at least one second coupling element is designed as a recess which is set back in the axial direction with respect to the first end face. The at least one gear part may comprise a plurality of, preferably three, second coupling elements of the at least one second coupling element, which may be arranged evenly distributed in the circumferential direction.

Preferably, the at least one first coupling element and the at least one second coupling element can be coupled to each other, particularly preferably by rotating the respective gear parts relative to each other in the circumferential direction. The at least one first coupling element and the at least one second coupling element may each have an undercut, wherein preferably the undercut of the at least one first coupling element can be brought into engagement with the undercut of the at least one second coupling element. The at least one first coupling element and the at least one second coupling element can collectively form a coupling unit in the manner of a bayonet fitting.

In the case of gear parts that are arranged adjacent to two of the gear parts, the at least one first coupling element and/or the at least one second coupling element may be arranged, in the manner described above, on the first end face of the respective gear part and on a second end face of the gear part arranged opposite the first end face in the axial direction.

At least one gear part of the gear parts preferably has an inner surface arranged radially within the toothed ring. Particularly preferably, each of the gear parts has an inner surface arranged radially within the toothed ring. The at least one second coupling element may be designed as a recess in the inner surface.

In a preferred embodiment, the at least one gear part has a shoulder projecting radially inwards beyond the inner surface and extending at least partially circumferentially around the axis of rotation. The shoulder may extend fully circumferentially around the axis of rotation. The shoulder allows an axial force to be transmitted from the gear to the central element and vice versa. Preferably, the shoulder is arranged at an axial end of the at least one gear part, which is particularly preferably arranged opposite the first end face in the axial direction.

The inner surface may have a drive gearing having at least one drive tooth for transmitting torques acting around the axis of rotation. This allows the torques from the at least one gear part to be transmitted to the central element, for example. Preferably, the at least one drive tooth is arranged parallel to the axial direction. In an alternative embodiment of the inner surface, the inner surface may be free of a drive gearing for transmitting torques acting around the axis of rotation. Preferably, gear parts having a drive gearing are arranged adjacent to gear parts whose inner surface is free of a drive gearing. This allows the gear parts without an inner surface to be rotated relative to the gear parts with an inner surface. This allows the respective gear parts to be brought into the coupled state.

In a preferred embodiment of the invention, the gear has exactly two or exactly three gear parts. In such a configuration, the gear may be particularly easy to mount.

In a development of the invention, two of the gear parts are identically designed. Particularly preferably, the gear has exactly two gear parts, said gear parts being identical in design.

An assembly according to the invention comprises the gear described above and a central element arranged radially within the toothed ring, wherein the central element is designed as a shaft or bearing. The bearing may be designed, in particular, as a roller bearing. The central element is preferably designed to abut the inner surface. A fit between the inner surface and the central element can be designed as a transition fit or an interference fit.

A gear mechanism according to the invention comprises at least one gear and/or an assembly as described above, as well as a mating gear which meshes with the at least one gear, wherein the mating gear is in engagement with each of the gear parts. Due to the engaged mating gear, the gear parts of the at least one gear are rotatable relative to each other in the circumferential direction only within the limits of the backlash. This prevents the coupled state from being released through rotation of the gear parts relative to each other.

In one possible embodiment, the gear mechanism is designed as a planetary gearing with at least one planetary gear, wherein the at least one planetary gear is formed by the at least one gear.

One possible application is an actuator in a motor vehicle that incorporates the previously described gear mechanism. Another possible application is a drive train of an electrically powered bicycle or an electrically powered small motorcycle, which has the gear mechanism described above.

Exemplary embodiments of the invention are explained with reference to the following figures. In the drawings:

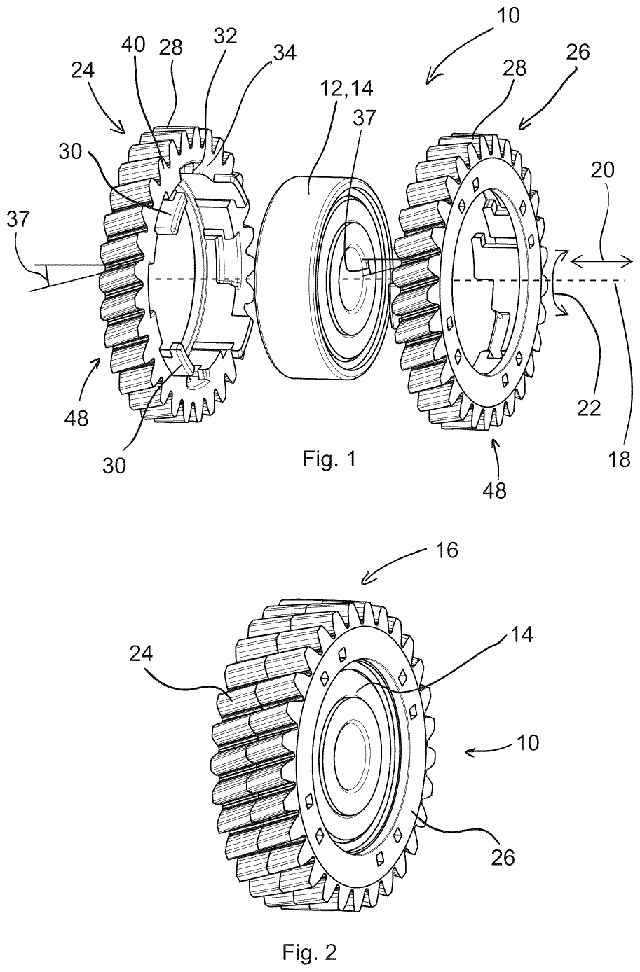

FIG. 1 shows an exploded view of a first exemplary embodiment of an assembly;

FIG. 2 shows a perspective view of the exemplary embodiment shown in FIG. 1;

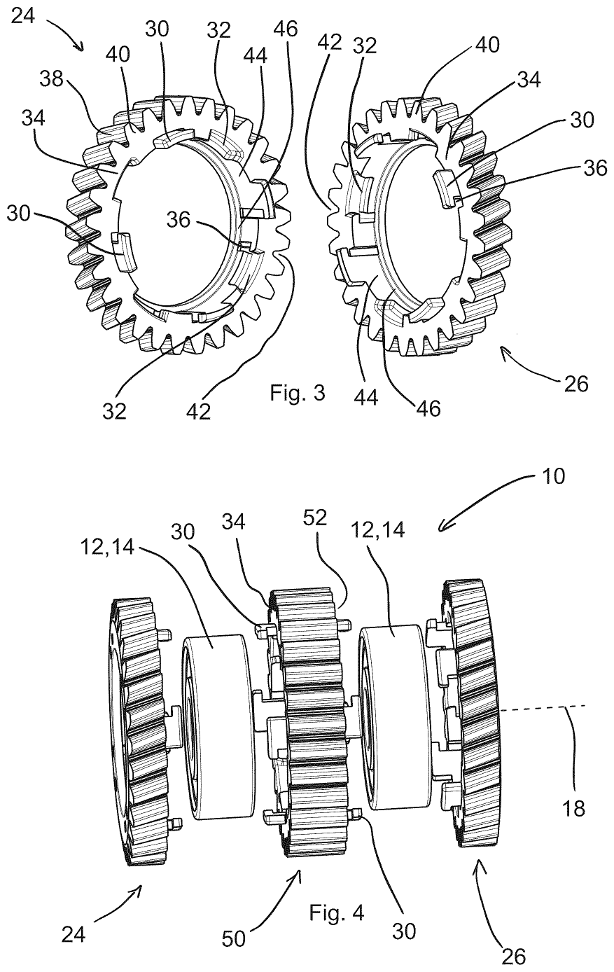

FIG. 3 shows a perspective view of the gear parts of the exemplary embodiment shown in FIG. 1;

FIG. 4 shows an exploded view of a second exemplary embodiment of an assembly;

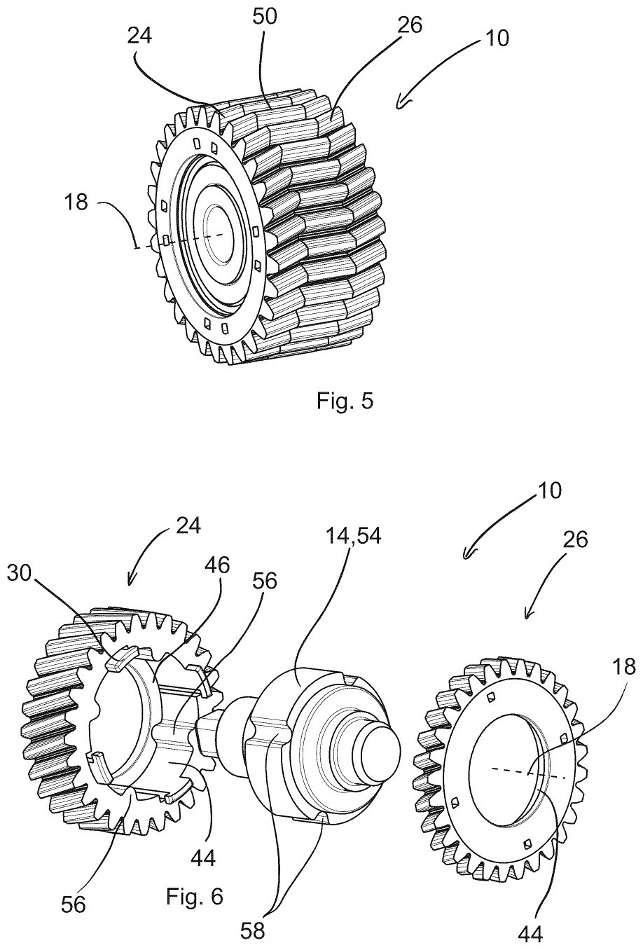

FIG. 5 shows a perspective view of the exemplary embodiment shown in FIG. 4;

FIG. 6 shows an exploded view of a third exemplary embodiment of an assembly; and

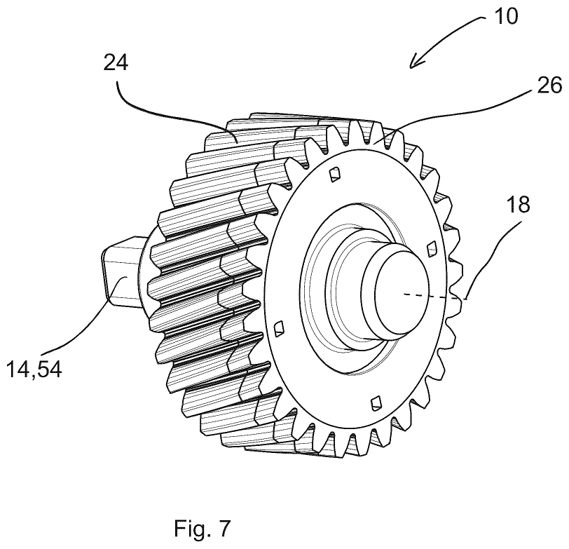

FIG. 7 shows a perspective view of the exemplary embodiment shown in FIG. 6.

FIGS. 1 to 7 show different exemplary embodiments. The same reference numbers are used for identical and functionally identical parts. For the sake of clarity, not all reference numbers are used in every figure.

FIGS. 1 and 2 show a first exemplary embodiment of an assembly 10, which will be used to explain the arrangement in detail by way of example. The assembly 10 comprises a central element 14 designed as a bearing 12, preferably as a roller bearing, and a gear 16 designed as a spur gear. The gear 16 comprises an axis of rotation 18 with an axial direction 20 and a circumferential direction 22 arranged perpendicular to the axial direction 20.

The gear 16 shown in FIG. 1 comprises a first gear part 24 and a second gear part 26, which are designed as separate components and are arranged adjacent to each other in the axial direction 20. Each of the gear parts 24, 26 has a toothed ring 28 arranged in the circumferential direction 22 around the axis of rotation 18. The gear parts 24, 26 are preferably arranged coaxially to the axis of rotation 18. The gear parts 24, 26 can be brought into a coupled state by rotating them relative to each other in the circumferential direction 22, in which state the gear parts 24, 26 are firmly connected to each other in the axial direction 20, so that axial forces can be transmitted between the gear parts 24, 26. While FIG. 1 shows an exploded view of the assembly 10, FIG. 2 shows the gear parts 24, 26 in the coupled state.

As shown, in particular, in FIG. 3, for establishing the coupled state of the gear parts 24, 26, each of the gear parts 24, 26 has three first coupling elements 30 and three second coupling elements 32 that can be coupled to the first coupling elements 30. Each of the gear parts 24, 26 has a first end face 34 arranged perpendicular to the axis of rotation 18. The first coupling elements 30 and the second coupling elements 32 are arranged evenly distributed in the circumferential direction 22 on the first end face 34 of the first gear part 24 and on the first end face 34 of the second gear part 26.

The first coupling elements 30 are designed to project beyond the first end face 34 in the axial direction 20. The second coupling elements 32 are designed as recesses which are set back in the axial direction 20 with respect to the first end face 34. Each of the first coupling elements 30 and each of the second coupling elements 32 has an undercut 36. The undercuts 36 of the first coupling elements 30 and the undercuts 36 of the second coupling elements 32 can be brought into engagement with each other by rotating the gear parts 24, 26 relative to each other in the circumferential direction 22. The first coupling elements 30 and the second coupling elements 32 thus form a coupling unit in the manner of a bayonet fitting. In the coupled state, the gear parts 24, 26 are, in particular, positively connected to each other.

It can be seen, in particular from FIG. 3, that the gear parts 24, 26 are arranged to be rotatable relative to each other in the circumferential direction 22 in the coupled state as far as the undercuts 36 allow. When engaging with a mating gear of the gear 16, the gear parts 24, 26 can align themselves with the mating gear, so that the gear 16 can compensate for tolerances such as misalignments or deformations of axles. It can also be seen from FIG. 3 that in the first exemplary embodiment the first gear part 24 and the second gear part 26 are identical. As shown in FIG. 1, the first gear part 24 and the second gear part 26 have, in particular, identical helix angles 37.

As can be seen, in particular, from FIG. 1, the gear parts 24, 26 are arranged, in the coupled state, without any biasing relative to each other in the circumferential direction 22. In particular, the gear 16 is free of a biasing element, such as a spring element, which would initiate a biasing force between the gear parts 24, 26.

As shown in FIGS. 1 and 3, the toothed ring 28 of each of the gear parts 24, 26 has a plurality of teeth 38, each with tooth end faces 40 arranged perpendicular to the axis of rotation 18. In the coupled state, the adjacent gear parts 24, 26 can be arranged relative to each other such that their tooth end faces 40 are arranged opposite each other in the axial direction 20. In particular, none of the tooth end faces 40 are positioned opposite a tooth gap 42 between the teeth 38. This allows the gear parts 24, 26 to be firmly connected to each other in the axial direction 20 when engaged with a mating gear. As shown in particular in FIG. 2, the tooth end faces 40 of the adjacent gear parts 24, 26 abut each other and are arranged without offset relative to each other in the circumferential direction 22.

FIGS. 1 and 3 further show that the gear parts 24, 26 each have an inner surface 44 arranged radially inside the toothed ring 28. The central element 14 is designed to abut the inner surface 44. The second coupling elements 32 are each designed as a recess in the inner surface 44.

The first gear part 24 and the second gear part 26 each have a shoulder 46 projecting radially inwards beyond the inner surface 44 and extending fully circumferentially around the axis of rotation 18. The central element 14 is arranged abutting the shoulder 46. The shoulder 46 allows an axial force to be transmitted from the gear 16 to the central element 14 and vice versa. The shoulder 46 is arranged at an axial end 48 of the first gear part 24 or of the second gear part 26, the axial end 48 being arranged opposite the first end face 34 in the axial direction 20.

With regard to the second exemplary embodiment shown in FIGS. 4 and 5, the following will focus substantially on its differences compared to the first exemplary embodiment shown in FIGS. 1 and 2.

FIG. 4 shows that the central element 14 of the assembly 10 comprises two bearings 12. As regards the gear 16 of the second exemplary embodiment, the first gear part 24 and the second gear part 26 are also identically designed. Furthermore, the gear 16 has a third gear part 50 designed as a separate component, which is arranged in the axial direction 20 between the first gear part 24 and the second gear part 26. The third gear part 50 preferably does not have a shoulder 46.

The third gear part 50 has a first end face 34 and a second end face 52 opposite the first end face 34 in the axial direction 20 and arranged perpendicular to the axis of rotation 18. The first end face 34 of the third gear part 50 is arranged adjacent to the first end face 34 of the first gear part 24. The second end face 52 of the third gear part 50 is arranged adjacent to the first end face 34 of the second gear part 24. Corresponding to the arrangement on the first end faces 34 of the first gear part 24 and the second gear part 26, the third gear part 50 has on each of its end faces 34, 52 three first coupling elements 30 and three second coupling elements 32 that can be coupled to the first coupling elements 30. The first coupling elements 30 and the second coupling elements 32 are each arranged evenly distributed in the circumferential direction 22. The third gear part 50 can be brought into the coupled state with the first gear part 24 and the second gear part 26 by rotating them in the circumferential direction 22 relative to the first gear part 24 and the second gear part 26 in the manner described above.

As also shown in FIGS. 4 and 5, the third gear part 50 has straight teeth and therefore a helix angle of 0°. Thus, the helix angle of the third gear part 50 differs from the helix angle 37 of the first gear part 24 and the second gear part 26.

With regard to the third exemplary embodiment shown in FIGS. 6 and 7, the following will also focus substantially on its differences compared to the first exemplary embodiment shown in FIGS. 1 and 2.

As shown in particular in FIG. 6, in the assembly 10 of the third exemplary embodiment the central element 14 is designed as a shaft 54. The first gear part 24 and the second gear part 26 are individually designed. Thus, the first gear part 24 is wider in the axial direction 20 than the second gear part 26. In addition, the inner surface 44 of the first gear part 24 has a drive gearing having four drive teeth 56 for transmitting torques acting around the axis of rotation 18. The drive teeth 56 are arranged parallel to the axial direction 20 and engage indentations 58 in the shaft 54. The inner surface 44 of the second gear part 26 adjacent to the first gear part 24 is free of a drive gearing that would transmit a torque between the central element 14 and the second gear part 26. This allows the second gear part 26 to be rotated relative to the first gear part 24 in the circumferential direction 22, so that the first gear part 24 and the second gear part 26 can be brought into the coupled state. The gear 16 of the third exemplary embodiment can thus be fixed radially and axially on the shaft 54.

The respective first gear part 24 and the respective second gear part 26 of the shown exemplary embodiments as well as the third gear part 50 of the second exemplary embodiment are preferably designed as injection-molded plastic parts.

### LIST OF REFERENCE NUMBERS

10 Assembly
12 Bearing
14 Central element
16 Gear
18 Axis of rotation
20 Axial direction
22 Circumferential direction
24 First gear part
26 Second gear part
28 Toothed ring
30 First coupling element
32 Second coupling element
34 First end face
36 Undercut
37 Helix angle
38 Tooth
40 Tooth end face
42 Tooth gap
44 Inner surface
46 Shoulder
48 Axial end
50 Third gear part
52 Second end face
54 Shaft
56 Drive tooth
58 Indentations

1. A gear (16), in particular spur gear, for a gear mechanism, comprising an axis of rotation (18) with an axial direction (20) and a circumferential direction (22), a plurality of gear parts (24, 26, 50) designed as separate components and arranged adjacent to one another in the axial direction (20), wherein each of the gear parts (24, 26, 50) has a toothed ring (28) circumferentially arranged around the axis of rotation (18), and wherein the gear parts (24, 26, 50) can each be brought into a coupled state by rotating them relative to one another in the circumferential direction (22), in which state the gear parts (24, 26, 50) are each firmly connected to one another in the axial direction (20), characterized in that the gear parts (24, 26, 50) are arranged, in the coupled state, without any biasing relative to each other in the circumferential direction (22).

2. The gear according to claim 1, characterized in that the gear parts (24, 26, 50) are arranged in the coupled state to be rotatable relative to each other in the circumferential direction (22).

3. The gear according to claim 1, characterized in that the toothed ring (28) of each of the gear parts (24, 26, 50) has a plurality of teeth (38) with tooth end faces (40) arranged perpendicular to the axis of rotation (18), wherein, in the coupled state, adjacent gear parts (24, 26, 50) can each be arranged such that their tooth end faces (40) are arranged opposite each other in the axial direction (20).

4. The gear according to claim 1, characterized in that the gear parts (24, 26, 50) are designed as injection-molded parts, preferably as plastic injection-molded parts.

5. The gear according to claim 1, characterized in that the gear parts (24, 26, 50) have the same and/or different helix angles (37).

6. The gear according to claim 1, characterized in that at least one gear part of the gear parts (24, 26, 50) has at least one first coupling element (30).

7. The gear according to claim 6, characterized in that at least one gear part of the gear parts (24, 26, 50) has at least one second coupling element (32) that can be coupled to the at least one first coupling element (30).

8. The gear according to claim 1, characterized in that at least one gear part of the gear parts (24, 26, 50) has an inner surface arranged radially inside the toothed ring (28).

9. The gear according to claim 8, characterized in that the at least one gear part (24, 26) has a shoulder (46) projecting radially inwards beyond the inner surface (44) and extending at least partially circumferentially around the axis of rotation (18).

10. The gear according to claim 8, characterized in that the inner surface has a drive gearing having at least one drive tooth (56) for transmitting torques acting around the axis of rotation (18).

11. The gear according to claim 1, characterized in that the gear (16) has exactly two or exactly three of the gear parts (24, 26, 50).

12. The gear according to claim 1, characterized in that two of the gear parts (24, 26, 50) are identical.

13. An assembly (10) comprising a gear (16) according to claim 1, and a central element (14) arranged radially within the toothed ring (28), wherein the central element (14) is designed as a shaft (54) or bearing (12).

14. A gear mechanism with at least one gear (16) according claim 1 and/or an assembly (10) and a mating gear which meshes with the at least one gear (16), wherein the mating gear is in engagement with each of the gear parts (24, 26, 50).

15. The gear mechanism according to claim 14, characterized in that the gear mechanism is designed as a planetary gearing with at least one planetary gear, wherein the at least one planetary gear is formed by the at least one gear (16).
